(19) United States
(12) Patent Application Publication
(10) Pub. No.: US 2017/0036560 A1
(43) Pub. Date: Feb. 9, 2017

(54) METHOD FOR LOAD BALANCING OF CHARGING STATIONS FOR MOBILE LOADS WITHIN A CHARGING STATIONS NETWORK AND A CHARGING STATIONS NETWORK

(71) Applicant: NEC Europe Ltd., Heidelgerg (DE)

(72) Inventors: Anett Schuelke, Gaiberg (DE); Roman Kurpatov, Munich (DE); Nitin Maslekar, Heidelberg (DE)

(21) Appl. No.: 15/304,074

(22) PCT Filed: Apr. 22, 2014
(86) PCT No.: PCT/EP2014/058050

§ 371 Date: Oct. 14, 2016

(51) Int. Cl. B60L 11/18; G05F 1/66

(52) U.S. Cl. CPC B60L 11/1844; B60L 11/1838; G05F 1/66

(57) ABSTRACT

A method for load balancing of charging stations for mobile loads within a charging stations network includes performing, based on a prediction of a charging demand of the mobile loads, a distribution of an energy-power-range limitation (ΔE, ΔP)_{p, lim} for each of the charging stations p under consideration of a definable optimization parameter, wherein p=1, . . . , n and wherein n and p are integers. Under consideration of the distribution, an adaptation and/or selection of at least one transportation parameter of a mobile load is performed so as to at least partially fulfill the energy-power-range limitation (ΔE, ΔP)_{p, lim} for each of the charging stations p or for a definable number of the charging stations p.

### CROSS-REFERENCE TO PRIOR APPLICATION

This application is a U.S. National Stage Application under 35 U.S.C. §371 of International Application No. PCT/EP2014/058050 filed on Apr. 22, 2014. The International Application was published in English on Oct. 29, 2015 as WO 2015/161862 A1 under PCT Article 21(2).

### FIELD

The present invention relates to a method for load balancing of multiple charging stations for mobile loads, particularly for Electric Vehicles, EVs, within a charging stations network, wherein on the basis of a prediction of a charging demand of the mobile loads a distribution of an energy-power-range limitation (ΔE, ΔP)_{p, lim} for each charging station p is performed under consideration of a definable optimization parameter, wherein p=1, . . . , n and wherein n and pare integers, and wherein under consideration of said distribution an adaptation and/or selection of at least one transportation parameter of at least one mobile load is performed in order to at least partially fulfill the energy-power-range limitation (ΔE, ΔP)_{p, lim} for each charging station p or for a definable number of charging stations p.

Further, the present invention relates to a charging stations network, comprising: means for load balancing of multiple charging stations for mobile loads, particularly for Electric Vehicles, EVs, means for distributing an energy-power-range limitation (ΔE, ΔP)_{p, lim} for each charging station p on the basis of a prediction of a charging demand of the mobile loads and under consideration of a definable optimization parameter, wherein p=1, . . . , n and wherein n and p are integers, and means for adapting and/or selecting of at least one transportation parameter of at least one mobile load under consideration of said distribution and in order to at least partially fulfill the energy-power-range limitation (ΔE, ΔP)_{p, lim} for each charging station p or for a definable number of charging stations p.

### BACKGROUND

Integration of electric vehicles into transportation or power industry domain has been investigated in research and trials around the world. One of the major challenges is still hold on the sustainable charging of the vehicles as well as the energy delivery for the EV charging needs within cities and large-area transportation—street—networks. As of today, the major focus is given to the process of EV charging, physical connectivity aspects, as well as it's linking to the power grid with regard to charging scheme—connectivity, power.

According to prior art the grid stability management follows either of these 2 schemes:
(a) Generation is following load. This is a traditional concept with central generation only and minor or no natural fluctuation of generation resources.
(b) Load is following generation. This is a new paradigm shift caused by increasing penetration of fluctuating sources.

To realize those, interactions between supply and consumers are in use with various extent. Concepts applied in the industry are demand-response/demand-side-management—ranging from controllable household appliances to industrial scale—for load management, combination of bulk generation and secondary energy resources, and various energy storage schemes.

Primarily, there are two basic concepts to be applied to a device/unit: (i) usage of time-tolerance, and (ii) capacity-tolerance. In general, devices have either one of the capability. Time-tolerance is used for all types of devices or processes which can accept a delay or advance in energy usage, e.g. electrical appliances, cooling houses. They have normally fixed power rates to work, so that time-tolerance comes either by comfort/preference shifting to run the device, or by using intrinsic storage functions like thermal storage for cooling/heating. Capacity-tolerance is possible for devices which can reduce their power/energy usage either by different operational modes, or by flexibility of power adaption, like electrical battery storages.

Looking on EVs, the battery charging process can be influenced by the chosen power level for charging. This, however, has a strong influence on the charging time of an individual EV, and on the charging throughput time when considering an EV fleet with a given limited set of charging stations, EVCS.

From the viewpoint of integration in travel intelligence, currently the following approaches have been considered in different variations:
R&D+deployment: Provisioning of a map of nearby charging spots, including no information, sometimes including pricing information, max power information, or availability of charging spots.
R&D: considering booking service to reserve charging spots, mostly via parking spots.
R&D: integrating transport means to address battery limitations for individual EVs as well as fleets.

The link to the power grid is today limited by the information about the power characteristics of the station. Challenges of integrating into power grid management schemes are mainly approached by:
R&D: Balancing a specific charging location—time and local profile concepts—, see WO 2013/056990 A2 as well as many examples for EV charging-enabled parking spaces/lots management.
R&D: Demand analysis with forecast into power grid management—other loads/generations will be adjusted to serve the balancing—, see WO 2013/045449 A2.
R&D: Charging assignment to support travel parameters, e.g. shortest travel time, minimizing waiting times, see WO 2013/045449 A2.
R&D: Cooperative balancing between different power grid segments governed by their local grid segment control, which individually aims for the exploitation of local generation versus local demands, especially inter-grid balancing needs using intelligent transport information for forecasting and EV charging guidance.

Within this document the following glossary is relevant:

| | |
|---|---|
| EV Charging Station | Charging location providing a variety of n > 1 |
| (EVCS) | independent charging stations with same or |
| | different power levels |
| Electric Vehicle (EV) | Movable Electric Load described by charging |
| | profile P_EV(t) defined by the state-of-charge |
| | (SOC) and its battery characteristic. |
| EMS | Energy Management System |
| ETA | Estimated Arrival Time |
| OBU | On-Board Unit - communication unit within EVs |
| | used for e.g. travel routing |
| ORG | Online Route Guidance - entity to provide route |
| | guidance and navigation services |
| CDP | Charging Demand Predictor - entity to calculate |
| | the charging need at a certain time/location given |
| | on SOC, route information and travel |
| | preferences/conditions |
| State-of-charge (SOC) | State-of-Charge: Charged battery level usable for |
| | driving a given distance. SOC is impacted by |
| | battery characteristics, and car usage pattern. |

### SUMMARY

In an embodiment, the present invention provides a method for load balancing of charging stations for mobile loads within a charging stations network. Based on a prediction of a charging demand of the mobile loads, a distribution of an energy-power-range limitation (ΔE, ΔP)_{p, lim} is performed for each of the charging stations p under consideration of a definable optimization parameter, wherein p=1, . . . , n and wherein n and p are integers. Under consideration of the distribution, at least one of an adaptation or selection of at least one transportation parameter of at least one of the mobile loads is performed so as to at least partially fulfill the energy-power-range limitation (ΔE, ΔP)_{p, lim} for each of the charging stations p or for a definable number of the charging stations p.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is illustrating an overview of an embodiment of a charging stations network according to the invention,

FIG. 2 is illustrating a negotiation process for energy-power-range limitations per charging station in the charging stations network according to an embodiment of a method according to the invention,

FIG. 3 is illustrating an example algorithm for a possible negotiation process to determine the energy-power-range limitations per charging stations in the charging stations network according to an embodiment of a method according to the present invention,

FIG. 4 is illustrating a negotiation process for the route optimizations within the energy-power-range limitation per charging station in the charging stations network according to an embodiment of a method according to the invention and

FIG. 5 is illustrating an example algorithm defining the best set of routes for the EVs in need of charging on a given charging station p according to an embodiment of a method according to the present invention.

### DETAILED DESCRIPTION

In an embodiment, the present invention improves and further develops a method for load balancing of multiple charging stations for mobile loads within a charging stations network and an according charging stations network for allowing a very efficient use of charging stations within a charging stations network.

According to an embodiment of the invention it has been recognized that a load balancing of multiple charging stations for mobile loads within a charging stations network can be particularly efficient by a consideration of at least one transportation parameter of at least one mobile load. In a first step a distribution of an energy-power-range limitation for each charging station is performed under consideration of a definable optimization parameter, wherein such a distribution is based on a prediction of a charging demand of the mobile loads. The energy-power-range limitation defines a limitation regarding energy and power to be provided by the charging station to a mobile load. In a second step, in order to at least partially fulfill the energy-power-range limitation for each charging station or for a definable number of charging stations an adaptation and/or selection of at least one transportation parameter of at least one mobile load is performed under consideration of said distribution. Within the first step the definable optimization parameter impacts the distribution of the energy-power-range limitation which shall be provided for fulfilling of a predicted charging demand of the mobile loads. In the second step at least one transportation parameter of at least one mobile load is adapted and/or selected under consideration of said distribution and in order to at least partially fulfill the energy-power-range limitation. By a suitable adaptation and/or selection of at least one transportation parameter of at least one mobile load an energy-power-range limitation of a charging station can be fulfilled easily. This results in maintaining the distribution of energy-power-range limitations according to the definable optimization parameter. Thus, an optimization process can be reached by the adaptation and/or selection step of said at least one transportation parameter.

As a result, a very efficient use of charging stations within a charging stations network is possible.

Within a preferred embodiment the adaptation and/or selection of at least one transportation parameter can result in a modification of the charging demand or of the prediction of a charging demand of at least one mobile load. Such a modification of the charging demand or of the prediction of a charging demand can provide an adapted basis for the distribution process within the first step of the method.

For providing a very economic method the optimization parameter can be defined for finding a low cost distribution or the lowest cost distribution. The efficiency of the use of the charging stations can be provided by cost saving.

Within a further preferred embodiment the mobile load or the mobile loads can be transformed into time tolerant and capacity tolerant mobile loads. By suitable adaptation and/or selection of at least one transportation parameter of at least one mobile load this time and capacity tolerance can be realized in a very easy way.

Regarding a very simple distribution the energy-power-range limitation (ΔE, ΔP)_{p, lim} can be equally distributed for each charging station p. In other words, each charging station p has the same energy-power-range limitation (ΔE, ΔP)_{p, lim}. However, depending on the individual situation the energy-power-range limitation (ΔE, ΔP)_{p, lim} can be distributed for each charging station p under consideration of a factor in the form of a past balancing potential, economical strength within a network grid and/or strategic location. Thus, by selectively distributing the energy-power-range limitations between the charging stations a very efficient use of the charging stations within the charging stations network can be realized.

The prediction of a charging demand for the first step of the inventive method can depend on various parameters. Preferably, the prediction of a charging demand can depend on at least one transportation parameter. Such a transportation parameter influences the individual charging demand of the mobile load. For example, a longer route results in a higher charging demand than a shorter route.

Generally, a charging demand regarding energy and power to be provided to a mobile load can be a function of time and location.

For taking account of individual situations and circumstances a charging demand can consider a route requirement, route requirements of different routes, a location, a direction, a time condition, a travel time, an estimated arrival time, ETA, a speed, a driving pattern, a current charging need, a predicted charging need, a charging time, a charging mode, a charging level and/or a battery level. It is also possible that a charging demand considers more than one of said different parameters.

The at least one transportation parameter can depend on individual situations. Within a preferred embodiment the at least one transportation parameter can be one or more of a user preference, a route, a route guidance, a routing information, a distance, a direction, a charging time, a travel time, a speed, a waiting time and a break.

With regard to a simple access to a transportation parameter the at least one transportation parameter can be provided by an intelligent transport system or service, ITS. Thus, modern and comfortable transport systems or services can be integrated within the inventive method and charging stations network.

For providing a very efficient method, the method can be performed in a reactive manner on or after the cause of a load exceeding or having exceeded a definable threshold. As soon as a definable cause of load exceeding arises the method can be activated or start automatically. Thus, a suitable load balancing of multiple charging stations can be provided.

Within a further preferred embodiment the method can be performed dynamically. In other words, the steps of the inventive method can be repeated after definable periods of time or in case of a definable event or within a definable time window.

For providing a very efficient use of the energy stations during the adaptation and/or selection a user preference and/or a traffic condition and/or a weather condition can be considered. Thus, an individual adaptation to individual situations and circumstances is possible.

Further preferred, during the adaptation and/or selection an ITS or data from an ITS can be exploited. In this way, a suitable adaptation to actual traffic situations is possible.

Further preferred, the energy-power-range limitation (ΔE, ΔP)_{p, lim} for each charging station p can be adapted under consideration of a user interaction/feedback and/or user preference and/or real-time traffic condition. This provides the possibility of a quick adaptation of energy-power-range limitations in response to changed circumstances or preferences.

For realizing the inventive method or charging stations network according to an embodiment the adaptation and/or selection can be performed by a de-centralized management scheme or by a centralized management scheme. Depending on the individual situation a user can select the kind of the management scheme. Within a preferred embodiment the adaptation and/or selection can be performed by neighbored charging stations in a bi-lateral manner.

The charging stations network can comprise different functional entities. Preferably, said balancing means, said distributing means or said adapting and/or selecting means can comprise at least one of a communication system, route guidance or online route guidance, charging demand predictor, Energy Management System, EMS, of charging station or EMS control center.

Important aspects and features of embodiments of an embodiment of the inventive method and charging stations network are explained in the following:

An embodiment of the invention addresses the problem of utilizing intelligent transportation control in order to impact the charging load profiles in certain context requirements. A method for load balancing across a multitude of charging stations using charging demand prediction and traffic modifications—route guidance, incl. distances, speed, and break suggestions—to impact traffic-dependent delay and charging volume tolerance of EVs is provided in an embodiment. An embodiment of the invention provides a utilization of charging demand prediction or forecast, charging planning and traffic control actions in order to dynamically control the charging needs through aggregated time- and capacity-tolerant mobile loads. The proposed system can be based on the control of a charging station network of any kind—different power levels, energy levels, size, and service levels—within a load balancing scheme including local and remote charging stations, allowing for central as well as de-centralized control enforcement.

An embodiment of the invention can actively exploit the correlated parameter space between transportation—travel route guidance—, battery usage—speed/travel distance—, charging needs—SOC—, charging capacities of EV charging stations, EVCS, charging locations, grid balancing, etc. into a system for load balancing across a multitude of charging stations using charging demand prediction and traffic control to impact traffic-dependent delay and charging volume tolerance of EVs.

The proposed system in an embodiment can consider the integration of routing planners, route guidance, EV charging demand prediction into transforming the EVs into time- and capacity-tolerant mobile loads, so that these loads can be applied to load balancing between charging stations.

Besides the consideration of those domain-specific solution proposals, either in power grid, or in the ITS domain, the remaining issue is the usage of the coupling of both systems from the planning phase, including prediction, impacting the travel flow via distance and speed, up to the control of the power level in such a way, that different charging stations can cooperatively balance the load across multiple stations. An embodiment of the invention can address the means of controlling load levels within specific context boundaries—context here: combination of route and charging time, e.g. fastest route+charging+waiting time—to impact the load balancing of a given system.

Embodiments of this invention address the cooperative load balancing for a network of charging stations—locally diverse—by exploiting intelligent transportation services to gain a high utilization efficiency, and fulfill power constraints on the charging stations and/or charging stations network. The prime idea is to enable a system to impact the demand prediction and planning through the flexibility given by route guidance.

The proposed method according to an embodiment can be realized by a system comprising:
Communication system configured to enable communication and control to/from
   EMS Control Center of remote charging units
To the components and service units:
   Online Route Guidance(s)
   EV Charging Demand Predictor
   EMS of Charging Station
   optionally including Routing planner(s) integrated in or independent of Online Route Guidance(s)

The aim of embodiments of the invention is to use intelligent transportation means in order to influence the charging patterns and to balance the charging demand (ΔE, ΔP) as function of time and location. Respecting user preferences like route requirements or time conditions, preferable charging mode, driving pattern—human style/factor—can be considered via the transportation guidance services. In this way, the method influences the EV charging demand profile by transforming the EVs into time- AND capacity-tolerant mobile loads.

In general, the method can be applied in a reactive manner on/after the cause of the critical load situation. Prediction allows to react to a some extent prior the cause of a possible event. The proposed method combines load forecast with means of controlling the load profile in time and location utilizing the mobility parameters, e.g. distance, direction, speed and external factors like traffic and weather conditions, of these mobile loads.

This method and charging stations network allow remote locations of charging stations, e.g. parking place companies with different locations in cities, fast charging network, charging networks of delivery companies and/or other fleet control companies, to impact the efficiency of their remote charging stations in the network, and fulfill power demands of the power grid network, e.g. time, location, grid dependencies.

Charging station networks can therefore gain an advantage in the energy market, as active load-balancing enabled customer, or even integrating with self-supply as active prosumers—as the method and charging stations network allow a better demand forecast for the individual stations and the serving charging network.

Depending on the time of day, additional energy services for non-used capacities can be created. Due to optimizing a high utilization of given power capacities without crossing the power limitations, the method and charging stations network increase the efficiency for the charging of the fleet, and integrating into intelligent transportation routing.

Further important aspects of embodiments of the present invention:
Impacting the EV charging needs through travel modifications—e.g. route guidance, incl. distances, speed, break suggestions—in time and charging capacity
Utilization of EV mobility for transforming the EVs into time- and capacity-tolerant mobile loads through traffic control procedures
Combination of charging prediction and on-demand modification control
Control of a charging station network of any kind—e.g. different power levels, energy levels, size, service levels—within a load balancing scheme including local and remote charging stations

Embodiments of the present invention can comprise the following important features:
1) Load Balancing optimization of multitude of charging stations in a physical—belonging to same grid balance region—or virtual—linked through economical aspects—e.g. logistics of fleet—charging station network through:
   a. Active transforming the EVs into time- AND capacity-tolerant mobile loads by impacting the charging profile for a certain point of location and time through modifications of transportation parameters
   b. Utilization of the instantaneous as well as predicted charging needs
   c. Impacting charging demand forecast along the—time, location, context—profile
2) Integration of ITS services—e.g. traffic control, route guidance, green driving, etc.—into active load profile demand prediction/modification and control for charging needs
3) Load Balancing negotiations between multitude of charging stations within a charging network supporting
   a. Central EMS control
   b. Distributed EMS control

An embodiment of the present invention can comprise active transforming the EVs into time- AND capacity-tolerant mobile loads by impacting the charging profile for a certain point of location and time through modifications of transportation parameters for a set of location-distinct charging stations which are managed together for energy and power management.

Traffic control is already a wide-used method to impact transportation demand. The integration of these well-established services linked to the challenges of charging demands are still not considered well.

The proposed method according to an embodiment enables new services for various areas to actively enable load balancing for the new domain of EV charging on charging network scheme integrated into the control space of travel and logistics management.

Through exploitation of the method into planning and online guidance, charging infrastructure can be used more efficiently and leads to reduced costs. Well-managed networks are enabled to actively participate on energy service market (prosumers-type).

The method assumes a certain level of EV intelligence to communicate its travel and charging needs, and assumes cooperation with ITS services.

Embodiments of this invention provide a system or charging stations network and a method for cooperative load balancing in a network of charging stations—locally diverse—controlled by a EMS control center by exploiting intelligent transportation services to gain a high utilization efficiency, and fulfill power constraints on the charging stations and/or charging stations network. The prime idea is to enable a system to impact the demand prediction and planning through the flexibility given by route guidance. The EMS Control Center enables a balancing across the charging network as well as the serving of power/energy commands from the power grid aggregated over the charging stations network.

The proposed method according to an embodiment can be realized by a system or charging stations network comprising:
Communication system configured to
   retrieve data about charging status of plurality of electric vehicles
   transmit routing information to electric vehicles
Online Route Guidance(s) configured to
   retrieve charging demand data, e.g. charging levels, preferred SOC limits for charging, from requesting EVs, travel information, e.g. location, direction, time, speed, estimated arrival time, ETA, . . .
   communicate with EV Charging Demand Predictor to estimate charging planning along travelled route
   retrieve online intelligent transport information about traffic characteristics, e.g. traffic density, traffic congestions, route deviations ,etc.
   calculate a route variation according to needed time (Δt) and capacity-tolerance (ΔE, ΔP) needed for the preferred charging station (ΔE, ΔP) according to the charging mode, preferred power level
   communicate route guidance information to EV and negotiate needed route and/or travel adaptations to recommended charging station—list—, as control variable, e.g. speed, distance, directions
EV Charging Demand Predictor configured to
   retrieve information about charging status—e.g. SOC, battery characteristics, etc.—, travel route—e.g. distance, expected speed, driving pattern—, user preferences
   estimate the charging demand prediction for possible charging locations
   communicate with the Routing planner(s) and/or Online Route Guidance(s) the requested set of charging demand information
EMS of Charging Station configured to
   Communicate with the Routing planner the expected charging demand load and negotiate any given pre-requisites for (E,P)-limitations for route planning
   Communicate with the Online Route Guidance the expected charging demand load and negotiate the needed balancing adjustments (ΔE, ΔP) according to (E, P)-limitations
   Communicate the charging demand status to the EMS Control Center, and negotiate (ΔE, ΔP)-limitations for the charging station with the EMS Control Center
EMS Control Center of remote charging units configured to
   Communicate the charging demand status to/from network of EMS of Charging Station(s), and
   negotiate (ΔE, ΔP)-limitations with the individual EMS of Charging Station
optionally including Routing planner(s) integrated in or independent of Online Route Guidance(s) configured to
   retrieve data of trip planning and charging levels,
   build an overall deviation of (ΔE, ΔP) by considering the road related conditions,
   communicate with EV Charging Demand Predictor to estimate charging planning along planned route—forecast for charging station groups on planned route
   communicate route planning information with EV,

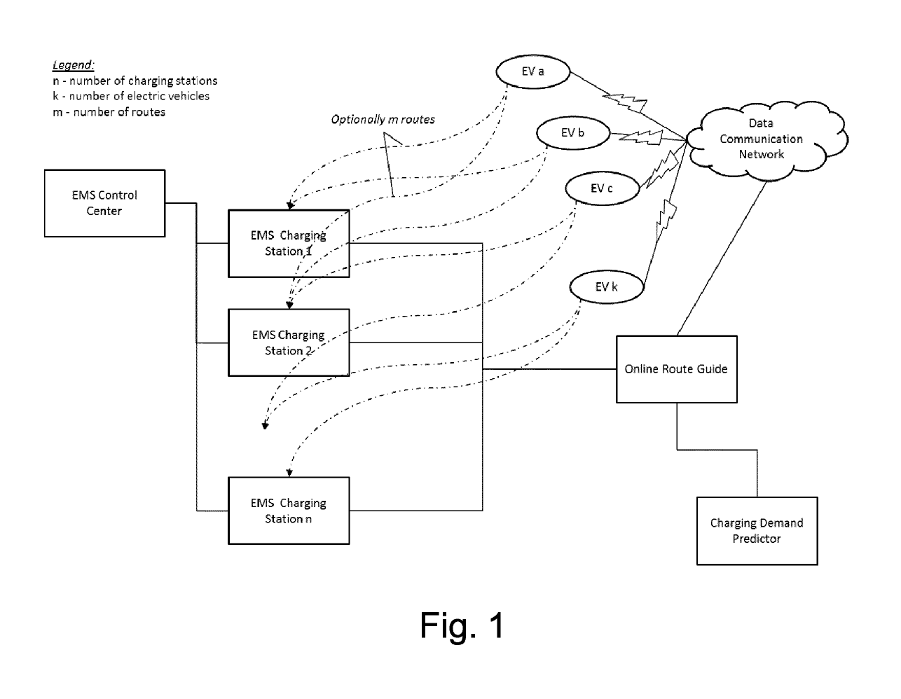

An embodiment of a system or charging stations network is illustrated in FIG. 1.

The EMS control center is connected to the local EMS of the remote charging stations. The charging stations' EMS can retrieve charging demand forecast via so-called online routing guides, ORG. These ORGs analyze the routes—planned or online—of the registered EVs, and are able to provide route guidance for multiple routes to the EV following user and travel preferences, e.g. selection of streets, travel time, speed preferences, charging location network choices, etc. The ORGs integrate or link to Charging Demand Prediction service units to calculate the expected charging demand for selected routes. A data communication network connects all components either fixed or over mobile connections. Especially for the communication with the route guidance clients hosted in the EVs, e.g. in the onboard units, OBU, the adapted route guidance is communicated to the EV user, and is provided as guidance to the charging station.

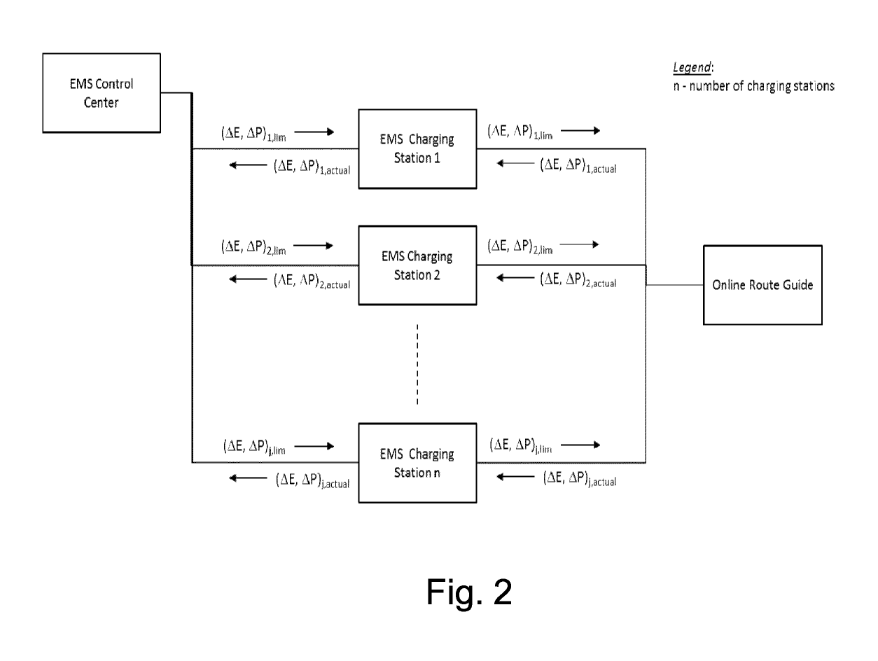

In a preferred embodiment, the EMS control center negotiates the limits of the (ΔE, ΔP)_{k, lim} ranges with each of the k charging stations as the first step. After finding the lowest cost solution, the individual EMSs of the k charging stations trigger the route adaption with the online route guide(s). FIG. 2 represents the first step given as negotiation process within the EMS charging network. Triggered through the EMSs control center, the EMSs of the charging systems retrieve the charging forecast with its flexibility range for a given period in time, or any other requested context, e.g. time, location, region. Starting from a given distribution of the (ΔE, ΔP)_{k, lim} for all k charging stations, the EMS control center, the EMSs of local stations and the Online Route guidance units negotiate the (ΔE, ΔP) variations across the network until they reach the required optimum between system demand and EV flexibility range. The (ΔE, ΔP)_{k, lim} can be equally distributed, but can also include factors like past balancing potential, economical strength within network grid, strategic location, etc.

The method is considered to be dynamic, meaning that within a given time window for energy restriction request a fine-granulated adapting process can be applied realizing a continuous and more reactive process.

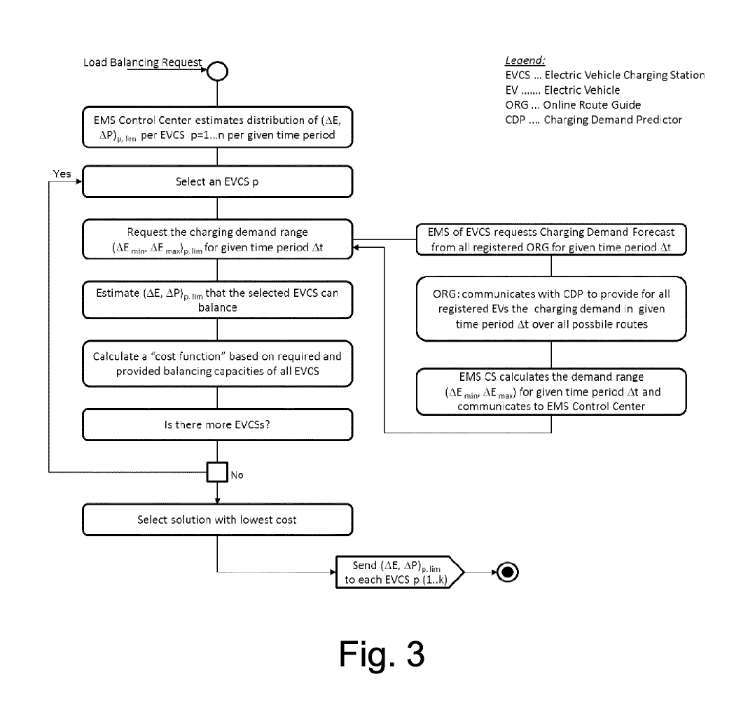

FIG. 3 represents an example algorithm for the estimation of the lowest cost solution to define the energy-power-ranges (ΔE, ΔP)_{k, lim} of the k charging stations of the charging stations network.

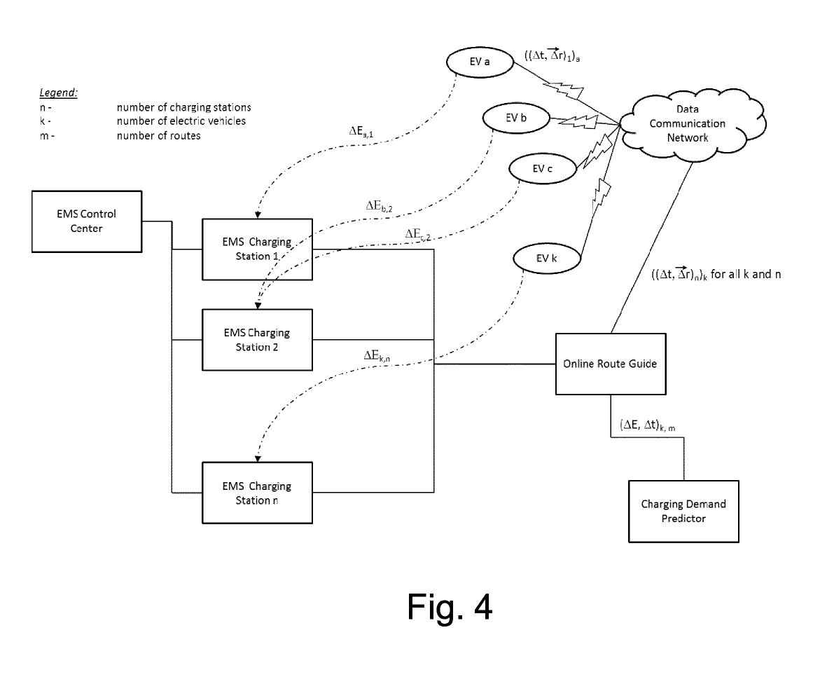

In the second step, each charging station EVCS will negotiate the possible route adaptations considering the traffic conditions, required stops, e.g. traffic signals, and durations, forced stops, e.g. traffic jams, in order to fulfill the given range limitation for energy and power. FIG. 4 provides a respective system illustration.

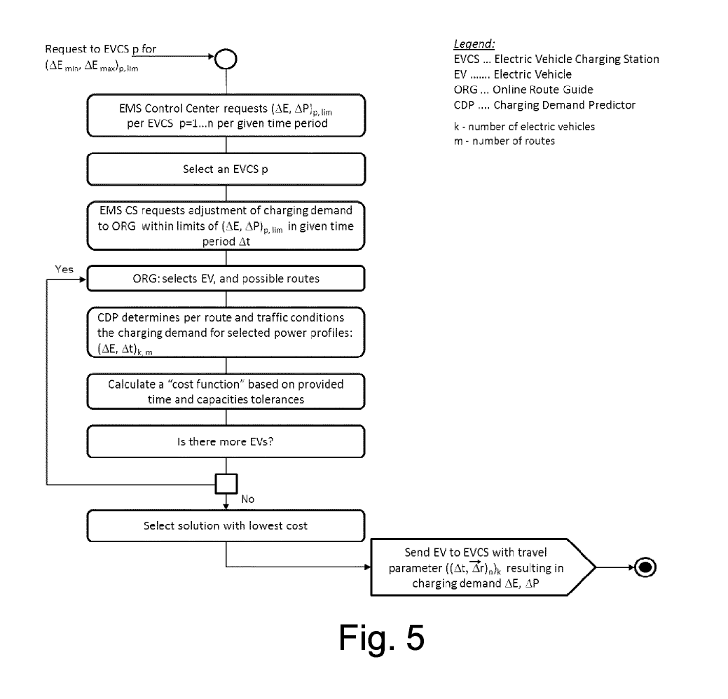

An example implementation of an algorithm is presented in FIG. 5. This example implementation is based on the target to find the best route per EV from all possible routes based on travel parameters, e.g. travel time, charging time, waiting time, breaks, streets selections, etc., optimized into the energy-power-range for the charging station. This example takes into account the variation potential of all EV possible to charge on the given charging station, and optimizes for the best solution.

In order to serve different users, user preferences, e.g. regarding route choices—like: sticking on main routes only—, waiting time settings through planned breaks, or even charging preferences, e.g. medium charging only on city trips, can be taken into account by the adjustment for travel parameters.

The charging stations network or system and method is flexible in respect to EV users who are not participating in the system, but appear as stochastic load on the EV charging network. Various methods for prediction of these loads can be used, integrating e.g. historical charging profiles and statistics for non-guided users.

In this preferred embodiment, the route guidance is considered as basis for the fleet logistics. The route guidance looks at objectives from both domains—energy and transport—and finds the best route for each EV to ensure the negotiated (ΔE, ΔP)_{k, lim} ranges per station and for the station network.

In another embodiment, the fleet management can be handled in a different approach in order to respect e.g. impacts on delivery time handling or similar. In such case, the method of the two-step approach can be more tightly integrated in order to integrate EV user interaction and feedback into the process and enable a re-negotiation process with the EMS control center involving charging stations from the whole or partial network.

Integration of EV user interaction/feedback and/or real-time integration of traffic conditions can lead to (ΔE, ΔP)_{k, lim} adaptation needs within the time period. To support real-time dynamics, the system can also be realized in a de-centralized management scheme for the re-negotiation of the (ΔE, ΔP)_{k, lim}. Therefore in a further embodiment, the adaptations of neighbored charging stations can be installed as bi-lateral adaptions given by e.g. regional or economical context, and will be reported to the EMS control center, e.g. for (ΔE, ΔP)_{k, lim} history records needed in fairness concepts.

In another embodiment, the online route guidance can enforce its route and travel adaptation needs through direct connection with the traffic control center in order to impact e.g. speed, re-routing—distances—and traffic lights—timings—for entire traffic—un-correlated fleet management—over large regions, e.g. high traffic points.

A further embodiment will extend the integration of traffic control and charging management into charging and logistics planning, up to charging booking services.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for load balancing of charging stations for mobile loads within a charging stations network, the method comprising:
based on a prediction of a charging demand of the mobile loads, performing a distribution of an energy-power-range limitation (ΔE, ΔP)_{k, lim} for each of the charging station p under consideration of a definable optimization parameter, wherein p=1, . . . , n and wherein n and p are integers, and
under consideration of the distribution, performing at least one of an adaptation or a selection of at least one transportation parameter of at least one of the mobile loads so as to at least partially fulfill the energy-puwer-range limitation (ΔE, ΔP)_{p, lim} for each of the charging stations p or for a definable number of the charging stations p.

2. The method according to claim 1, wherein the at least one of the adaptation or the selection of the at least one transportation parameter results in a modification of the prediction of the charging demand of at least one of the mobile loads.

3. The method according to claim 1, wherein the optimization parameter is defined so as to find a low cost distribution or a lowest cost distribution.

4. The method according to claim 1, wherein at least one of the mobile loads is transformed into at least one time tolerant and capacity tolerant mobile load.

5. The method according to claim 1, wherein the energy-power-range limitation (ΔE, ΔP)_{p, lim} is equally distributed for each of the charging stations p.

6. The method according to claim 1, wherein the energy-power-range limitation (ΔE, ΔP)_{p, lim} is distributed for each of the charging stations p under consideration of a factor in a form of at least one of a past balancing potential, economical strength within a network grid or a strategic location.

7. The method according to claim 1, wherein the prediction of the charging demand is performed depending on at least one transportation parameter.

8. The method according to claim 1, wherein the charging demand regarding energy and power to be provided to one of the mobile loads is a function of time and location.

9. The method according to claim 1, wherein the charging demand considers at least one of a route requirement, route requirements of different routes, a location, a direction, a time condition, a travel time, an estimated arrival time, ETA, a speed, a driving pattern, a current charging need, a predicted charging need, a charging time, a charging mode, a charging level or a battery level.

10. The method according to claim 1, wherein the at least one transportation parameter is at least one of a user preference, a route, a route guidance, a routing information, a distance, a direction, a charging time, a travel time, a speed, a waiting time or a break.

11. The method according to claim 1, wherein the at least one transportation parameter is received from an. intelligent transport system or service, ITS.

12. The method according to claim 1, wherein the method is performed in a reactive manner on or after cause of a load exceeding or having exceeded a definable threshold.

13. The method according to claim 1, wherein the method is performed dynamically.

14. The method according to claim 1, wherein, during the at least one of the adaptation or selection, at least one of a user preference, a traffic condition or a weather condition is considered.

15. The method according to claim 1, wherein, during the at least one of the adaptation or selection, an intelligent transport system or service, ITS, or data from the ITS is exploited.

16. The method according to claim 1, wherein the energy-power-range limitation (ΔE, ΔP)_{p, lim} for each of the charging stations p is adapted under consideration of at least one of a user interaction/feedback, a user preference or a real-time traffic condition.

17. The method according to claim 1, wherein the at least one of the adaptation or the selection is performed by a de-centralized management scheme.

18. The method according to claim 1, wherein the at least one of the adaptation or the selection is performed by neighbored charging stations in a bi-lateral manner.

19. A charging stations network comprising:
means for load balancing of charging stations for mobile loads,
means for distributing an energy-power-range limitation (ΔE, ΔP)_{k, lim} for each of the charging stations p based on a prediction of a charging demand of the mobile loads and under consideration of a definable optimization parameter, wherein p=1, . . . , n and wherein n and p are integers, and
means for at least one of adapting or selecting of at least one transportation parameter of at least one of the mobile loads under consideration of the distribution so as to at least partially fulfill the energy-power-range limitation (ΔE, ΔP)_{p, lim} for each of the charging stations p or for a definable number of the charging stations p.

20. The charging stations network according to claim 19, wherein the balancing means, the distributing means or the adapting and/or selecting means comprises at least one of a communication system, route guidance or online route guidance, charging demand predictor, Energy Management System, EMS, of charging station or EMS control center.
